(19) United States
(12) Patent Application Publication
(10) Pub. No.: US 2026/0196382 A1
(43) Pub. Date: Jul. 9, 2026

(54) Low Resistance Capacitive Cable

(71) Applicant: Enertechnos Limited, Surrey, ENG (GB)

(72) Inventors: Ashkan Daria Hajiloo, London (GB); Mansour Salehi-Moghadam, Surrey (GB)

(21) Appl. No.: 19/132,532

(22) PCT Filed: Nov. 23, 2023
(86) PCT No.: PCT/EP2023/082913

§ 371 Date: May 23, 2025

(30) Foreign Application Priority Data
Nov. 23, 2022 (EP) 22209216.5
May 25, 2023 (EP) 23175297.3

(51) Int. Cl. H01B 7/30; H01B 7/36; H01B 9/00; H01B 9/04

(52) U.S. Cl. CPC H01B 7/303; H01B 7/306; H01B 7/361; H01B 9/006; H01B 9/04

(57) ABSTRACT

A capacitive cable which includes (a) a first plurality of conductors for connection to a power source, (b) a second plurality of conductors for connection to a load, and (c) a dielectric material between the first plurality of conductors and the second plurality of conductors, wherein each conductor is individually insulated, and wherein at least one of the conductors of the first plurality of conductors and at least one of the conductors of the second plurality of conductors are woven or wound into one or more bundles such that each individual conductor repeatedly transitions, along a length of the one or more bundles, between an outside of the one or more bundles and an inside of the one or more bundles. The capacitive cable can be used as both a transmission line and a return line.

### INTRODUCTION

The present invention relates to power transmission cables comprising a capacitive power transmission system, hereinafter referred to as “capacitive cables”, to use of such cables for transmitting power, and to methods of transmitting power using such cables. In particular, the invention relates to a capacitive cable having reduced resistance compared to capacitive cables known in the prior art, as well as to use of such cables for transmitting power and to methods of transmitting power using such cables.

### BACKGROUND

Conventional power transmission cables (“conventional cables”) are known in the art and are described in, for example, GB 895,501. Capacitive cables for transmitting power between a power source and a load are also known and are described in, for example, EP 3996114, WO 2010/026380, WO 2019/234449, WO 2021/094783, WO 2021/094782, and WO 2020/120932.

Capacitive cables are known to be advantageous in certain situations because they can exhibit lower voltage losses when power is transmitted along their lengths than conventional cables, which means capacitive cables can be used to improve the efficiency of power transmission systems. This advantage is possible because capacitive cables exhibit much lower reactance than conventional cables.

Domestic power transmission systems in the UK use alternating current (“AC”) transmitted at a frequency of about 50 Hz. Similar systems in the USA transmit alternating current at a frequency of about 60 Hz. Power transmission systems comprising capacitive cables are known to be highly efficient when power/electricity is transmitted along the capacitive cables at these relatively low frequencies.

Whilst domestic power supply distribution networks use low frequency transmission of power, power supply distribution networks that use much higher frequencies are also known. For example, aircraft and airport power supply distribution networks typically transmit power at frequencies of about 400 Hz. Similar frequencies are used by power supply distribution networks in maritime applications. High frequency power transmission is also used in applications for wireless charging of electric vehicles. It will be appreciated that other high frequency power transmission applications are also known. At present in the UK and in the USA, power supply standards approve high frequency power supplies at frequencies of about 20 KHz and about 70-95 kHz (typically at about 80-85 kHz, and especially at about 85 kHz).

It is known that the magnitude of voltage losses when power is transmitted along a cable is dependent on the frequency at which that power is transmitted. Specifically, greater losses are observed when higher frequencies are used. When low frequencies, such as 50 Hz and/or 60 Hz, are used, the low reactance of capacitive cables is sufficient to keep the voltage losses along these cables to a minimum. However, large voltage losses have been reported to occur when power is transmitted along these cables at high frequencies. Known capacitive cables are thus not well-suited to applications wherein power is transmitted at a high frequency because these capacitive cables may not transmit power efficiently at such a frequency. This means it has not previously been possible to realise the advantages of using capacitive cables to transmit power at low frequencies when high frequencies are used instead.

The above problems associated with using capacitive cables for high frequency transmission of power have previously been thought to be caused by the high capacitance of these cables. Thus, high capacitance is currently considered by those skilled in the art to be undesirable for cables designed for transmitting power at a high frequency. For example, US 2015/041172 teaches that cables for efficiently transmitting power at high frequencies should be designed to have low capacitances. DE 10 2016 210 152 similarly teaches that cables having high capacitances exhibit undesirable heating and increased losses when power is transmitted along such cables at a high frequency. The present inventors, however, have newly identified that the above problems associated with using capacitive cables for high frequency transmission of power are, in fact, primarily caused by the high resistances of these cables, rather than the high capacitances thereof.

Accordingly, it is desirable to provide a capacitive cable suitable for efficiently transmitting power at a high frequency, with minimal voltage losses along its length. The present inventors are the first to recognise that this may be achieved by designing a capacitive cable to have low resistance.

Power transmission systems that use a capacitive cable as a transmission line to transfer power from a power source/supply to a load are known. These power transmission systems typically use the ground as a return line to return power from the load to the supply to complete the electrical circuit. Whilst these circuits typically operate with sufficiently low voltage losses when low frequency power transmission is used, a problem newly identified by the present inventors is that large voltage losses are typically observed when high frequency power transmission is used instead. This is particularly true in cases where the cable and/or the ground has/have highly resistive properties. These large voltage losses arise partly due to the high resistance of the transmission and/or return lines, and partly due to current flowing more readily along one line than the other, thereby giving rise to an imbalance between the current flow in the transmission line and the current flow in the return line.

It is therefore desirable to provide a power transmission system including a capacitive cable, wherein that power transmission system has low resistance and is thus suitable for high frequency transmission of power.

Furthermore, in power transmission systems including a capacitive cable as a transmission line and the ground as a return line, large electric fields and magnetic fields are typically generated around the ground/return line. These electric and magnetic fields, if generated at sufficiently large magnitudes, may be hazardous to the health of people and animals in close proximity to these fields, and may give rise to large voltage losses. When power is transmitted via such systems at low frequency, the electric and magnetic fields generated are usually sufficiently small in magnitude that these problems are of little concern. However, a problem newly identified by the present inventors is that when power is instead transmitted via such systems at high frequency, these electric and magnetic fields may be generated at much greater magnitudes, which may render such systems inefficient and dangerously hazardous to health. Using capacitive cables in high frequency power transmission systems has therefore proven impractical to date.

Accordingly, it remains desirable to provide a power transmission system including a capacitive cable as a transmission line, wherein the electric fields and magnetic fields generated around the return line are minimised, thereby increasing the safety and efficiency of such power transmission systems, and ensuring such power transmission systems are suitable for high frequency applications.

It also is desirable in general to provide alternative, and preferably improved, power transmission systems and capacitive cables.

### SUMMARY OF THE INVENTION

The invention provides a capacitive cable having lower resistance than known, prior art capacitive cables. The invention also provides use of a low resistance capacitive cable in a power transmission system and a method of transmitting power using a low resistance capacitive cable.

An advantage of the capacitive cable of the present invention is that the cable can be designed to have reduced, preferably minimal, resistance to current flow, as well as reduced, preferably minimal, reactance. The low reactance of the cable means the advantages of prior art capacitive cables over conventional cables may apply equally to the capacitive cable of the present invention. The low resistance of the cable of the invention means this cable may be particularly suitable for the transmission of power at a high frequency, which has previously been possible but nevertheless not ideal, even difficult to achieve, using known capacitive cables, as explained elsewhere.

Another advantage of the capacitive cable of the invention is that the cable can be designed to exhibit lower voltage losses along its length, reduced harmonics, and increased power delivery when power is transmitted compared to using a conventional cable of similar dimensions. Accordingly, the capacitive cable of the invention may exhibit more efficient transmission of power along its length than conventional cables of similar dimensions.

The capacitive cable of the invention may be suitable for efficiently transmitting power at any frequency typically considered to be “high frequency”, i.e. at a frequency of at least 350 Hz. The capacitive cable of the invention may be particularly suitable for efficiently transmitting power at a frequency of 400 Hz to 3 MHZ, especially at a frequency of 400 Hz to 2.8 MHZ. The capacitive cable of the invention may also be particularly suitable for efficiently transmitting power at a frequency corresponding with the frequencies approved by power supply standards in the UK and in the USA, i.e. frequencies of about 20 KHz and about 70-95 kHz (typically at about 80-85 kHz, and especially at about 85 kHz).

An advantage of using the capacitive cable of the invention in a power transmission system is that the resistance of the system may be reduced compared to power transmission systems using a prior art capacitive cable or a conventional cable instead.

A further advantage of using the capacitive cable of the invention in a power transmission system is that improved balance between the transmission and return lines may be achieved, thereby improving the efficiency of the system, compared to known power transmission systems. Alternatively or additionally, two capacitive cables of the invention, or two sub-cables of a capacitive cable of the invention, may be used in the same power transmission system (one as the transmission line, and the other as the return line), which may further improve the balance between the transmission and return lines, thereby maximising the efficiency of the system.

A third advantage of using the capacitive cable of the invention in a power transmission system is that, in embodiments wherein the ground is not used as a return line, electric fields and magnetic fields surrounding the return line can be reduced and can be localised to the vicinity of the cable, rather than extending across a wider area. This may render the power transmission system less hazardous to people and animals close to the power transmission system and may improve the efficiency of the system by minimising the electric and magnetic fields generated around the return line.

An advantage of the method of the invention is that power may be transmitted from a power source connected at/to one end of the capacitive cable to a load connected at/to the other end of the capacitive cable with minimal resistance and thus high efficiency, even if the power is transmitted at a high frequency.

### DETAILED DESCRIPTION OF THE INVENTION

According to a first aspect of the invention, there is provided a capacitive cable, comprising:
(a) a first plurality of conductors for connection to a power source,
(b) a second plurality of conductors for connection to a load, and
(c) a dielectric material between the first plurality of conductors and the second plurality of conductors,
   wherein each conductor is individually insulated.

The capacitive cable may be for transmitting power at a high frequency.

The above reference to “each” conductor being individually insulated is intended to mean that most of the conductors should be individually insulated. Thus, there may be one or more, e.g. a few, conductors which are not individually insulated. The important point is that enough of the conductors must be individually insulated to prevent, or at least substantially minimise, the number of direct electrical connections formed between the conductors, particularly between the first and second pluralities of conductors. Nonetheless, preferably all of the conductors are individually insulated.

The first plurality of conductors may be for connection to only the power source, i.e. not also to the load. Alternatively or additionally, the second plurality of conductors may be for connection to only the load, i.e. not also to the power source. Connecting the first plurality of conductors to only the power source and connecting the second plurality of conductors to only the load may establish a capacitive relationship between the first and second pluralities of conductors. It will be appreciated that “connection” in this context is intended to mean “direct electrical connection”.

The conductors may be of any material capable of conducting electricity. However, the conductors are preferably of copper or aluminium.

The conductors may be of any shape. Preferably, when viewed in cross-section from one end thereof, each conductor is circular, square, rectangular, or triangular in shape. It will be appreciated that different conductors may be of different shapes. However, preferably all of the conductors of the first plurality of conductors are of the same shape and all of the conductors of the second plurality of conductors are of the same shape. All of the conductors may be of the same shape.

The dielectric material may be any type of material having appropriate properties, such as a sufficiently large dielectric constant, to achieve a capacitive relationship between the first and second pluralities of conductors when the capacitive cable is in use, transmitting power. However, the dielectric material is preferably selected from the group consisting of polyvinyl chloride, low density polyethylene, high density polyethylene, ethylene propylene rubber (“EPR”), polyurethane, polyamide nylon ruslan, Grade 12 Nylon, polyethylene terephthalate, polypropylene, polyvinylidene chloride, tetrafluoroethylene, polytetrafluoroethylene, perfluoroalkyl, polyimide, silicone rubber, and aluminium-based dielectric tape.

The capacitive cable may comprise only one type of dielectric material. Alternatively, the capacitive cable may comprise more than one type of dielectric material. It will be appreciated that the type, number, and/or thickness of dielectric material(s) used in the capacitive cable is to be determined based on the application for which the capacitive cable is intended to be used, and may be selected based on the capacitive, mechanical, thermal, and/or other electrical properties of each type of dielectric material. Thus, references herein to “a dielectric material” are to be interpreted as meaning “one or more dielectric material(s)”.

The conductors may be individually insulated using any material capable of preventing the flow of current between adjacent conductors, i.e. capable of galvanically isolating adjacent conductors from each other. However, the insulation is typically of enamel. Preferably, the enamel is polyurethane or polyester-imide. The insulation may be a dielectric material.

At least one of the conductors of the first plurality of conductors and at least one of the conductors of the second plurality of conductors may be woven or wound into one or more bundles such that each individual conductor repeatedly transitions, along a length of the one or more bundles, between an outside of the one or more bundles and an inside of the one or more bundles.

At least one of the conductors of the first plurality of conductors and at least one of the conductors of the second plurality of conductors may be woven or wound into one or more bundles such that each individual conductor is repeatedly on an outside of the one or more bundles for a distance and on an inside of the one or more bundles for a distance along a length of the one or more bundles.

At least one of the conductors of the first plurality of conductors and at least one of the conductors of the second plurality of conductors may be woven or wound into one or more bundles such that along a length of the one or more bundles each conductor transitions repeatedly from an inside of the one or more bundles to an outside of the one or more bundles.

At least one of the conductors of the first plurality of conductors and at least one of the conductors of the second plurality of conductors may be woven or wound into one or more bundles such that along a length of the one or more bundles each conductor is at an outside of the one or more bundles for a part of the length of the one or more bundles and each conductor is at an inside of the one or more bundles for a part of the length of the one or more bundles.

At least one of the conductors of the first plurality of conductors and at least one of the conductors of the second plurality of conductors may be woven or wound into one or more bundles such that each conductor is at an outside of the one or more bundles at a part or parts of a length of the one or more bundles and at an inside of the one or more bundles at a part or parts of the length of the one or more bundles.

At least one of the conductors of the first plurality of conductors and at least one of the conductors of the second plurality of conductors may be woven or wound into one or more bundles such that each individual conductor is repeatedly on an outside of the one or more bundles for a part of the length and on an inside of the one or more bundles for a part of the length of the one or more bundles.

At least one of the conductors of the first plurality of conductors and at least one of the conductors of the second plurality of conductors may be woven or wound into one or more bundles such that along a length of the one or more bundles each conductor transitions repeatedly from an inside of the one or more bundles to an outside of the one or more bundles.

At least one of the conductors of the first plurality of conductors and at least one of the conductors of the second plurality of conductors may be woven or wound into one or more bundles such that along a length of the one or more bundles each conductor transitions between the inside and outside of the one or more bundles.

The weaving/winding of the conductors into a bundle or bundles as detailed above may reduce the resistance, specifically the alternating current (“AC”) resistance, of the capacitive cable when power is transmitted, in the form of alternating current, from one end of the capacitive cable to the other end thereof. In particular, weaving/winding the conductors in this manner may minimise the skin effect and/or the proximity effect exhibited by each conductor when power is transmitted compared to a capacitive cable wherein the conductors are not woven or wound in such a manner. Reducing the skin effect and/or proximity effect in this manner can substantially reduce voltage losses along the length of the cable.

As used herein, the term “capacitive cable” is intended to mean a cable that has a capacitive coupling within the conductor. The term “capacitive cable” does not refer to the capacitance properties of a conventional cable, i.e. a conventional conductive cable, such as that used in a conventional power transmission system. Neither does the term “capacitive cable” refer to capacitance between two isolated conductors in a conventional power transmission system. The term “capacitive cable” instead refers to a cable that is part of a capacitive transmission system, and which is represented in a circuit diagram as a capacitor. As mentioned above, examples of capacitive cables known in the art are described in EP 3996114, WO 2010/026380, WO 2019/234449, WO 2021/094783, WO 2021/094782, and WO 2020/120932.

As used herein, the term “conventional cable” is intended to mean a cable having a conductor that is for connection to or is connected to both the source and the load. Typically, one end of the conductor is connected to the source and the other end of the conductor is connected to the load.

As used herein, the term “transmission line” is intended to mean an electrical component used to transmit power from the source to the load in an electrical circuit/power transmission system. In contrast, the term “return line” is intended to mean an electrical component used to transmit power from the load to the source in an electric circuit/power transmission system. It will be appreciated that an electrical circuit requires both a transmission line and a return line in order to be complete and thus function as an electrical circuit.

As used herein, the term “conductor” is intended to mean any material capable of allowing electricity to pass through it, i.e. capable of conducting electricity. It will be appreciated that a conductor, in the context of a cable, typically has an elongated structure allowing it to be arranged along the length of the cable. A conductor having such a structure may also appropriately be described as a “conductive strand”, or simply as a “strand”.

As used herein, the term “dielectric material” is intended to mean any material having dielectric properties that, when positioned between a first conductor connected to a power source and a second conductor connected to a load, is capable of mediating a capacitive relationship between the first and second conductors when the power source is active, supplying power. It will be appreciated that the dielectric properties, e.g. the dielectric strength, of a particular material may be determined by factors such as the dielectric constant of the material, the dissipation factor of the material, the dielectric breakdown voltage of the material, the electrical susceptibility of the material, the dielectric polarisation of the material, the total polarisation of the material and the dielectric dispersion of the material.

As used herein, the term “insulation” is intended to mean any material that galvanically isolates one material from another. Thus, if a first conductor is said to be “insulated” from a second conductor, this means the insulation galvanically separates the first conductor from the second conductor.

As used herein, the term “bundle” is intended to be a collective term used to describe a plurality of conductors woven or wound together.

As used herein, the term “power transmission system” is intended to mean any electrical circuit wherein power is transmitted from a power source/supply to a load.

As used herein, the term “radial” is intended to mean the direction between the centre of the cable and the circumference of the cable when the cable is viewed in cross-section from one end of the cable.

As used herein, the term “cable” is intended to mean an electrical component used to transmit power between a power source and a load. Cables may transmit power on overhead pylons. Cables may transmit power from a domestic wall socket to a domestic electrical machine/appliance.

All of the conductors may be woven or wound into the one or more bundles.

Weaving/winding all of the conductors into the one or more bundles may maximise the efficiency of the cable, compared to embodiments wherein not all of the conductors are woven or wound into the one or more bundles, by ensuring that the skin effect and/or proximity effect is/are minimised in all of the conductors, not only in some of the conductors. It will be appreciated that this may help reduce the resistance of the capacitive cable.

The proportion of the length of the one or more bundles over which each conductor is at the outside of the bundle may be similar (or the same) between the conductors. Weaving/winding the conductors in this manner may ensure the skin effect and/or proximity effect is similar (or the same) in each of the conductors, rather than some of the conductors exhibiting larger skin effect and/or proximity effect than other conductors. It will be appreciated that this may help reduce the resistance of the capacitive cable.

The capacitive cable may be for transmitting power in a single-phase manner, a three-phase manner, a six-phase manner, or a nine-phase manner. Alternatively, more than nine phases may be used. In such embodiments, the capacitive cable may respectively be described as, i.e. be, a “single-phase capacitive cable”, a “three-phase capacitive cable”, a “six-phase capacitive cable”, a “nine-phase capacitive cable”, and so on.

It will be appreciated that any cable comprising at least three conductors may be used as a three-phase cable by appropriately connecting the conductors to respective phases of a three-phase power supply, or as a single-phase cable by connecting all of the conductors to a single-phase power supply.

It will similarly be appreciated that any cable comprising at least six conductors may be used as a six-phase cable by connecting the conductors to respective phases of a six-phase power supply, or as a three-phase cable by connecting the conductors (in pairs) to respective phases of a three-phase power supply, or as a single-phase cable by connecting all of the conductors to a single-phase power supply.

It will also be appreciated that any cable comprising at least nine conductors may be used as a nine-phase cable by connecting the conductors to respective phases of a nine-phase power supply, or as a three-phase cable by connecting the conductors (in groups of three) to respective phases of a three-phase power supply, or as a single-phase cable by connecting all of the conductors to a single-phase power supply.

It will be appreciated that, in general, the higher the number of phases used, the higher the efficiency of power transmission along the cable. However, it will also be appreciated that, in general, the higher the number of phases used, the higher the cost of transmitting power along the cable due to increased complexity of the power source/supply required. Thus, it will be appreciated that the selection of the number of phases to be used requires a trade-off between efficiency and cost.

There may be any number of conductors in the capacitive cable. However, preferably there are at least 300, more preferably at least 500, even more preferably at least 1000, and even more preferably at least 2000 conductors in each bundle. In a specific embodiment described in more detail below, there were 1600 conductors in one bundle and 1620 conductors in another bundle. Using such numbers of conductors may improve the ability of the capacitive cable to transmit current along its length with reduced resistance, making the capacitive cable particularly suitable for use in typical high frequency power transmission system applications including, for example, airport and aircraft applications, as well as maritime applications, and wireless electric vehicle charging applications. It will be appreciated that fewer conductors may be needed for transmitting the same amount of power if the cable is for connection as a three-phase capacitive cable than if the cable is for connection as a single-phase capacitive cable.

Similarly, it will be appreciated that even fewer conductors may be needed if the cable is for connection as a six-phase capacitive cable, and that even fewer conductors may be needed if the cable is for connection as a nine-phase capacitive cable.

The conductors may be woven or wound into one bundle and each conductor may be individually insulated using a dielectric material. Alternatively, the conductors may be woven or wound into a plurality of bundles. For example, the first plurality of conductors may be woven or wound into a first bundle and the second plurality of conductors may be woven or wound into a second bundle. As another example, the first plurality of conductors may be woven or wound into a first plurality of bundles and the second plurality of conductors may be woven or wound into a second plurality of bundles. In a variant of this example, the first plurality of bundles and the second plurality of bundles may be arranged into one or more concentric rings of bundles. As a third example, the first plurality of conductors and the second plurality of conductors may collectively be woven or wound into a plurality of bundles, wherein each bundle comprises at least one conductor of the first plurality of conductors and at least one conductor of the second plurality of conductors.

The conductors/bundles of conductors may be arranged around a former. The former may be positioned in a centre of the cable (when the cable is viewed in cross-section from one end thereof). The former may be of any material, but preferably is of plastic material or metal material.

Each conductor may be a non-tubular conductor or a tubular conductor, such as a tubular copper conductor. Tubular conductors may be advantageous because these may exhibit lower skin effect, and thus lower overall resistance, than non-tubular conductors when power is transmitted along/through these conductors at a high frequency.

Each conductor may be a copper-clad aluminium wire (“CCA wire”). Such conductors may be advantageous because these may be less expensive to manufacture than conductors made only of copper, and because these conductors may exhibit improved electrical conductivity compared to, and may be stronger than, conductors made only of aluminium.

Each bundle may be Litz wire. The Litz wire may be any type of Litz wire, but preferably is selected from the group consisting of basic Litz wire, concentric Litz wire, bunched Litz wire, formed Litz wire, taped Litz wire, extruded Litz wire, rectangular (“profiled”) Litz wire, served Litz wire, strain relief Litz wire, EFOLIT Litz wire, Litz magneto-plate wire (“LMPW”), Litz magneto-coated wire (“LMCW”), Type 1 Litz wire, Type 2 Litz wire, Type 3 Litz wire, Type 4 Litz wire, Type 5 Litz wire, Type 6 Litz wire, Type 7 Litz wire, Type 8 Litz wire, and Type 9 Litz wire. Notably, in conventional Litz wires, not all conductors thereof are necessarily insulated in such a manner that direct electrical connections therebetween are completely eliminated. Thus, in the invention, preferably all conductors are individually insulated to eliminate direct electrical connections therebetween.

The type of Litz wire used may depend on factors such as the frequency at which power is intended to be transmitted along the length of the cable, the magnitude of the current and/or voltage at which power is to be transmitted along the length of the cable, the maximum temperature increase that is acceptable for the cable in use, and/or the diameter of the conductors used. The present inventors have found that certain types of Litz wire may be preferred for certain frequencies of power transmission because these may transmit power more efficiently at those frequencies than other types of Litz wire.

In embodiments wherein the capacitive cable is for transmitting power at a frequency of between 400 Hz and 1 kHz, the Litz wire preferably is Type 8 Litz wire.

In embodiments wherein the capacitive cable is for transmitting power at a frequency of between 1 kHz and 2 MHz, the Litz wire preferably is selected from the group consisting of concentric Litz wire, bunched Litz wire, served Litz wire, formed Litz wire, Type 2 Litz wire, Type 7 Litz wire, and Type 8 Litz wire. In such embodiments wherein the frequency at which the power is to be transmitted is at the lower end of this range, i.e. between 1 kHz and 50 KHz, the Litz wire preferably is concentric Litz wire or Type 8 Litz wire. In embodiments wherein the frequency at which the power is to be transmitted is at a slightly higher frequency at the lower end of this range, i.e. between 50 KHz and 850 kHz, the Litz wire preferably is bunched Litz wire or Type 8 Litz wire.

In embodiments wherein the frequency at which the power is to be transmitted is at the higher end of this range, i.e. between 850 kHz and 2 MHZ, the Litz wire preferably is selected from the group consisting of served Litz wire, formed Litz wire, Type 2 Litz wire, Type 7 Litz wire, and Type 8 Litz wire.

The capacitive cable may additionally comprise a conductive screen. This “conductive screen” may alternatively be referred to as, for example, a “conductive shield”, or simply as a “screen” or as a “shield”. Typically, the conductive screen may be positioned towards the outside of the capacitive cable, i.e. towards the circumference of the cable when the cable is viewed in cross-section from one end thereof. Inclusion of a conductive screen may be beneficial because this screen may shield people and animals in the proximity of the capacitive cable from electric and magnetic fields generated around the cable when power is transmitted along the length of the cable. This may improve the safety of power transmission systems in which the capacitive cable is used. The conductive screen may be made of any conductive material.

Preferably, the conductive screen is of copper or aluminium. More preferably, the conductive screen is of a plurality of copper strands or a plurality of aluminium strands.

The conductive screen may be for connection as a return line. In power transmission systems wherein the screen is used as a return line, the screen may exhibit lower resistance than the ground (which may be used as the return line in power transmission systems wherein the conductive screen is not present), which means balance between the transmission line and the return line may be improved compared to using the ground as the return line.

Furthermore, the conductive screen may be Litz wire. This may be particularly advantageous in power transmission systems wherein the conductive screen is connected as a return line because using Litz wire as the conductive screen may ensure the resistance of the return line is minimised. Minimising resistance in the return line in this manner may ensure that, in use, greater balance is achieved between the transmission line and the return line, which may further improve the efficiency of the power transmission system.

In embodiments wherein the conductors are woven or wound into a plurality of bundles, the bundles may be distributed laterally with respect to each other or distributed radially with respect to each other.

The capacitive cable may be for connection as both a transmission line and a return line. Thus, the capacitive cable may comprise at least four bundles of conductors.

Preferably, the first plurality of conductors is woven/wound into at least two bundles and the second plurality of conductors is woven/wound into at least two bundles. More preferably, the first plurality of conductors is woven/wound into first and second bundles and the second plurality of conductors is woven/wound into third and fourth bundles. Such embodiments may be particularly advantageous because these may facilitate integration of the transmission and return lines into the same capacitive cable, e.g. by using one of the bundles formed by the first plurality of conductors and one of the bundles formed by the second plurality of conductors together as the transmission line, and by using another bundle formed by the first plurality of conductors and another bundle formed by the second plurality of conductors together as the return line. Having the first plurality of conductors woven/wound into first and second bundles and the second plurality of conductors woven/wound into third and fourth bundles may be particularly advantageous because this may facilitate ease of separation of the conductors for connection to the source from the conductors for connection to the load at the ends of the cable, as well as ease of separation of the conductors for the transmission line and the conductors for the return line from each other.

The insulation of the first plurality of conductors may be of a different colour to the insulation of the second plurality of conductors. For example, the insulation of the first plurality of conductors may be of red colour and the insulation of the second plurality of conductors may be of green colour. The use of different colours may be advantageous because it may enable the first and second pluralities of conductors to be readily identified by a person installing the capacitive cable at an installation site, thereby facilitating ease of separation of the two pluralities of conductors from each other at ends of the cable and connection of the first plurality of conductors to the power source and the second plurality of conductors to the load.

Alternatively or additionally, four different colours may be used, i.e. two colours may be used for the first plurality of conductors and two colours may be used for the second plurality of conductors. For example, the insulation of a first half of the conductors of the first plurality of conductors may be of a first colour (e.g. red), the insulation of a second half of the conductors of the first plurality of conductors may be of a second colour (e.g. blue), the insulation of a first half of the conductors of the second plurality of conductors may be of a third colour (e.g. green), and the insulation of a second half of the conductors of the second plurality of conductors may be of a fourth colour (e.g. yellow). The use of four colours may be particularly advantageous in embodiments wherein the capacitive cable is for connection as both a transmission line and a return line because it may enable the four groups of conductors (transmission/source, transmission/load, return/source, and return/load) to be readily identified.

The bundles may be arranged into two or more capacitive sub-cables within the capacitive cable. As used herein, the terms “capacitive sub-cable” and “sub-cable” are used interchangeably and are intended to refer to structures which, in isolation, have the characteristic features of capacitive cables that are explained elsewhere and herein. Accordingly, each capacitive sub-cable may comprise a first plurality of conductors for connection to the power source (but not to the load) and a second plurality of conductors for connection to the load (but not to the power source). The capacitive sub-cables may be distributed laterally with respect to each other, e.g. the capacitive sub-cables may be adjacent to each other when the capacitive cable is viewed in cross-section from one end thereof. Alternatively or additionally, the capacitive sub-cables may be distributed radially with respect to each other, i.e. one capacitive sub-cable may be radially outwards of another capacitive sub-cable when the capacitive cable is viewed in cross-section from one end thereof, such that the one capacitive sub-cable radially surrounds the other capacitive sub-cable. It will also be appreciated that arranging the bundles into two or more capacitive sub-cables may enable one or more of the capacitive sub-cables to be readily connected as a transmission line and one or more of the other capacitive sub-cables to be readily connected as a return line. Accordingly, the capacitive cable may comprise a first capacitive sub-cable for connection as a transmission line and a second capacitive sub-cable for connection as a return line.

The capacitive cable may comprise four bundles of conductors distributed laterally with respect to each other and arranged as two sub-cables, wherein each sub-cable comprises a bundle formed of the first plurality of conductors and a bundle formed of the second plurality of conductors. The two bundles of each sub-cable may be arranged diagonally with respect to each other or vertically with respect to each other, when the capacitive cable is viewed in cross-section from one end thereof. It will be appreciated that these arrangements may enable one sub-cable to be readily connected as the transmission line and the other sub-cable to be readily connected as the return line. Such embodiments are preferred since the inductance may be reduced compared to having the transmission and return lines provided in/as separate cables, which can improve balance between the transmission line and the return line, and thus efficiency of the cable.

To facilitate connection of the capacitive cable as both a transmission line and a return line, the capacitive cable may comprise:
(a) a first plurality of conductors for connection to a power source (but not to a load),
(b) a second plurality of conductors for connection to the load (but not to the power source),
(c) a third plurality of conductors for connection to the power source (but not to the load),
(d) a fourth plurality of conductors for connection to the load (but not to the power source),
(e) a dielectric material between the first plurality of conductors and the second plurality of conductors, and
(f) a dielectric material between the third plurality of conductors and the fourth plurality of conductors,
wherein the first plurality of conductors and the second plurality of conductors are collectively for connection as a transmission line,
wherein the third plurality of conductors and the fourth plurality of conductors are collectively for connection as a return line, and
wherein each conductor is individually insulated.

At least one of the conductors of the first plurality of conductors, at least one of the conductors of the second plurality of conductors, at least one of the conductors of the third plurality of conductors, and at least one of the conductors of the fourth plurality of conductors may be woven or wound into one or more bundles such that each individual conductor repeatedly transitions, along a length of the one or more bundles, between an outside of the one or more bundles and an inside of the one or more bundles.

It should be appreciated that, in use, a capacitive relationship must arise between the first plurality of conductors and the second plurality of conductors for the cable of the invention to be considered a “capacitive cable”. To achieve this, the first plurality of conductors should be connected to a power source (but not to a load) and the second plurality of conductors should be connected to the load (but not to the power source).

To ensure ease of connection of the conductors in this manner, the first plurality of conductors may be connected to each other at a first end of the capacitive cable and the second plurality of conductors may be connected to each other at a second end of the capacitive cable. It will be appreciated that there should be no direct electrical connections between the first and second pluralities of conductors along the length of the cable for a capacitive relationship to arise between the first and second pluralities of conductors when the cable is in use, transmitting power. In other words, the first and second pluralities of conductors should be galvanically isolated from each other for a capacitive relationship to arise between the first and second pluralities of conductors when the cable is in use, transmitting power.

In embodiments wherein the capacitive cable is for connection as both a transmission line and a return line, a first half of the first plurality of conductors may be connected to each other at a first end of the capacitive cable, a second half of the first plurality of conductors may be connected to each other at the first end of the capacitive cable, a first half of the second plurality of conductors may be connected to each other at a second end of the capacitive cable, and a second half of the second plurality of conductors may be connected to each other at the second end of the capacitive cable. This may ensure ease of connection of the conductors in the appropriate manner.

According to a second aspect of the invention, there is provided use of a capacitive cable according to the first aspect of the invention in a power transmission system, wherein:
(i) the first plurality of conductors is connected to the power source (but not to the load), and
(ii) the second plurality of conductors is connected to the load (but not to the power source).

The cable is used to transmit power. It should be appreciated that connecting the conductors in the above manner establishes a capacitive relationship between the first plurality of conductors and the second plurality of conductors. This ensures the cable transmits power from the source to the load as a capacitive cable.

The cable may be used to transmit power at a high frequency.

The first plurality of conductors and the second plurality of conductors may together be used as a transmission line and a ground or a conventional cable may be used as a return line. In such embodiments, the use of the capacitive cable of the first aspect of the invention, rather than a conventional cable, as the transmission line, may reduce the resistance of the transmission line compared to power transmission systems wherein a conventional cable is used as the transmission line instead. This can improve the efficiency of the system.

Alternatively, the first plurality of conductors and the second plurality of conductors may together be used as a transmission line and the conductive screen may be used as a return line. The conductive screen typically exhibits lower resistance when current is passed along it than the ground (the ground may be used as the return line in embodiments wherein the conductive screen is not present). This means balance between the transmission line and the return line can be improved, compared to using the ground as the return line.

As explained above in relation to the first aspect of the invention, the capacitive cable may be configured such that the conductors for use as the transmission line and the conductors for use as the return line are integrated into the same capacitive cable. Accordingly, the capacitive cable may be used as both a transmission line and a return line.

In embodiments wherein the first plurality of conductors and the second plurality of conductors are each woven/wound into a plurality of bundles, one or more of the bundles forming the first plurality of conductors and one or more of the bundles forming the second plurality of conductors may together be used as a transmission line, whilst one or more of the other bundles forming the first plurality of conductors and one or more of the other bundles forming the second plurality of conductors may together be used as a return line. Thus, the transmission and return lines may be integrated into the same capacitive cable. Such embodiments are preferred since the cable may be easier to install at an installation site compared to having the transmission and return lines provided in/as separate cables. In such embodiments, preferably the capacitive cable comprises at least four bundles of conductors.

In embodiments wherein the capacitive cable is used as a three-phase capacitive cable, there may not be a need to provide a return line separately to the transmission line. This may be because only one of the three phases of the transmission line will be active, transmitting power, at any given time, so one or both of the other two phases can thus be used as the return line at that time. This may be advantageous because reduced materials may be needed to manufacture the cable, compared to providing the transmission and return lines separately to each other.

According to a third aspect of the invention, there is provided use of a first capacitive cable according to the first aspect of the invention and a second capacitive cable according to the first aspect of the invention in a power transmission system, wherein:
(i) the first plurality of conductors of the first capacitive cable is connected to the power source (but not to the load),
(ii) the second plurality of conductors of the first capacitive cable is connected to the load (but not to the power source),
(iii) the first plurality of conductors of the second capacitive cable is connected to the power source (but not to the load), and
(iv) the second plurality of conductors of the second capacitive cable is connected to the load (but not to the power source).

The cables are used to transmit power. The cables may be used to transmit power at a high frequency.

The first capacitive cable may be used as a transmission line and the second capacitive cable may be used as a return line. Using a second capacitive cable as the return line, rather than the ground, a conventional cable, or a conductive screen, may further help improve balance between the transmission and return lines when power is transmitted along these lines, as a result of the two capacitive cables having very similar reactance and resistance to each other. Using two capacitive cables that are substantially identical to each other in such a system may further improve balance between the transmission and return lines when power is transmitted along these lines because these may have almost identical, if not perfectly identical, reactance and/or resistance to each other.

As used herein, the term “balance” is intended to describe the ratio of (i) the transmission line's impedance to current flow to (ii) the return line's impedance to current flow. A system described as “balanced” is intended to mean a system wherein the impedance of the transmission line is substantially equal to that of the return line, whilst an “unbalanced” system is intended to mean a system wherein the difference between these impedances is relatively high. It will be appreciated that a balanced system generally transmits power more efficiently than an unbalanced system. Perfect balance is the optimal outcome because it may reduce the voltage losses due to imbalance to zero, which may maximise the efficiency of the power transmission system. Whilst perfect balance (or approaching perfect balance) may be achieved in the most preferred embodiments of the invention, it is expected that many embodiments will achieve very good balance instead.

The first capacitive cable and the second capacitive cable may be woven or wound around each other. Twisting the two cables around each other in this manner may have several advantages. For example, electric and magnetic fields generated by the cables may be reduced, which may improve safety and efficiency of the power transmission system. Furthermore, in embodiments wherein the first and second capacitive cables are not woven or wound around each other, there is a risk that the electric and magnetic fields generated by one of these cables will interfere with power transmission in the other cable. This interference between the cables is known as “crosstalk” and decreases the efficiency of the system. Weaving/winding the two cables around each other may reduce crosstalk between the two cables, which may increase the efficiency of the system compared to embodiments without this weaving/winding. Additionally, weaving/winding the two cables around each other in this manner may reduce the susceptibility of the system to electric and magnetic fields produced by an external electromagnetic field source, i.e. an electromagnetic field source not forming part of the system, in the proximity of one or both of the cables.

According to a fourth aspect of the invention, there is provided a method of transmitting power, the method comprising:
(a) connecting the first plurality of conductors of a capacitive cable according to the first aspect of the invention to the power source (but not to the load),
(b) connecting the second plurality of conductors of the capacitive cable according to the first aspect of the invention to the load (but not to the power source), and
(c) activating the power source.

Activating the power source in this context can be effected by switching the power source on.

The method may be a method of transmitting power at a high frequency.

It will be appreciated that transmitting power, i.e. transmitting or conducting electricity (in the form of alternating current), in this manner may achieve highly efficient transmission of that power, given the advantages of using the capacitive cables of the invention detailed above. This method of transmitting power/electricity may thus be advantageous over prior art methods of transmitting power/electricity.

According to a fifth aspect of the invention, there is provided a capacitive cable, comprising:
(a) a first conductor for connection to a power source,
(b) a second conductor for connection to a load, and
(c) a dielectric material between the first and second conductors, wherein optionally each conductor is individually insulated, and wherein at least one of the conductors transitions between an outside and an inside of the cable.

According to a sixth aspect of the invention, there is provided a Litz wire or cable, comprising:
(a) a first conductor for connection to a power source,
(b) a second conductor for connection to a load, and
(c) a dielectric material between the first and second conductors.

It should further be appreciated that, in all aspects of the invention, the capacitive cable(s) may further comprise an outer sheath. The purposes of the outer sheath are to (i) protect the interior components of the cable from the surrounding environment, and (ii) hold the interior components of the cable in their correct positions in the cable.

### EXAMPLES

The invention is now illustrated by way of the following examples, with reference to the accompanying drawings, in which:

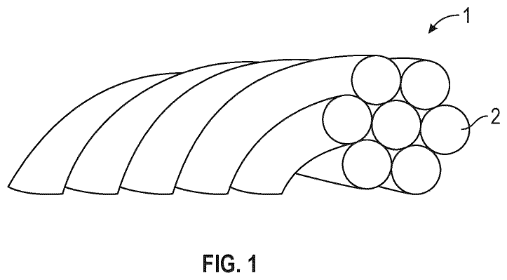

FIG. 1 shows a schematic perspective view of a bundle of a capacitive cable according to an embodiment of the first aspect of the invention;

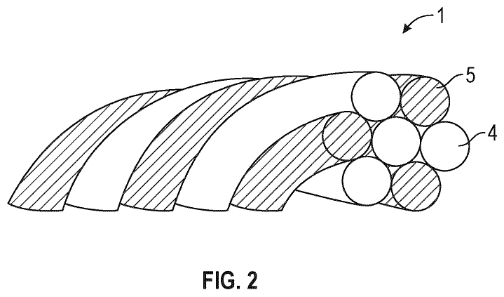

FIG. 2 shows a schematic perspective view of a bundle of a capacitive cable according to an embodiment of the first aspect of the invention, wherein the bundle comprises a first plurality of conductors and a second plurality of conductors;

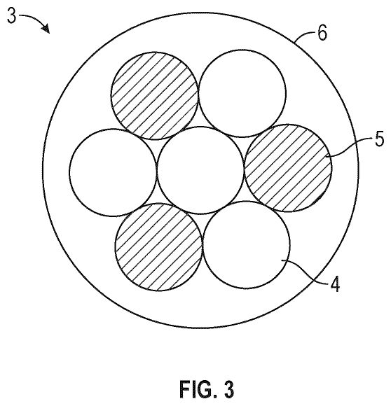

FIG. 3 shows a schematic cross-section (end view) of a capacitive cable comprising the bundle of FIG. 2;

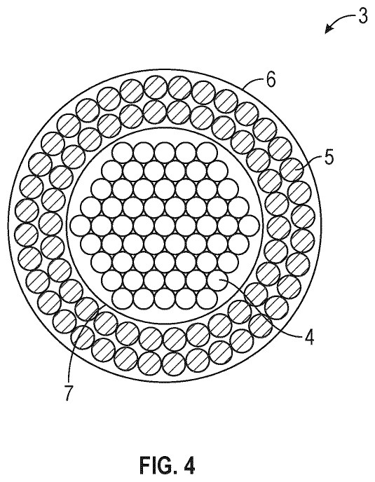

FIG. 4 shows a schematic cross-section (end view) of a capacitive cable according to an embodiment of the first aspect of the invention;

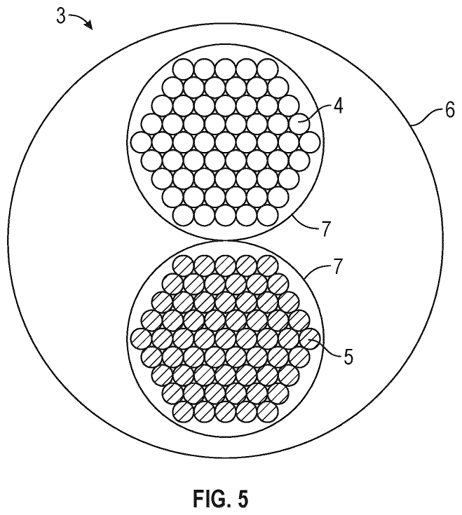

FIG. 5 shows a schematic cross-section (end view) of another capacitive cable according to an embodiment of the first aspect of the invention;

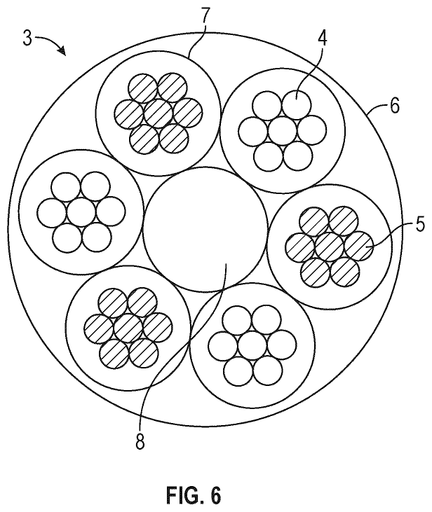

FIG. 6 shows a schematic cross-section (end view) of another capacitive cable according to an embodiment of the first aspect of the invention;

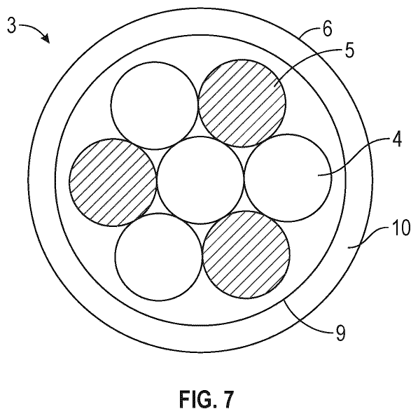

FIG. 7 shows a schematic cross-section (end view) of a capacitive cable similar to that shown in FIG. 3, but additionally comprising a conductive screen;

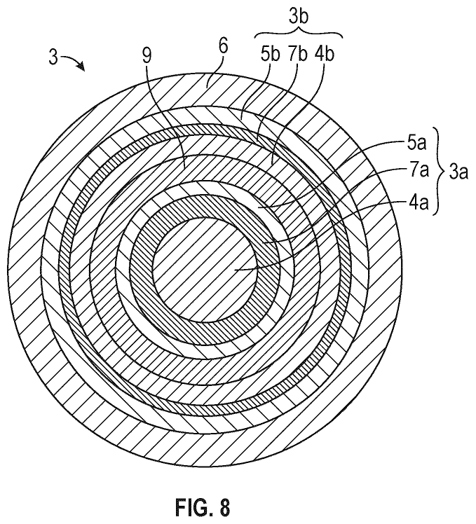

FIG. 8 shows a schematic cross-section (end view) of another capacitive cable according to an embodiment of the first aspect of the invention, wherein the bundles are arranged into two capacitive sub-cables distributed radially with respect to each other;

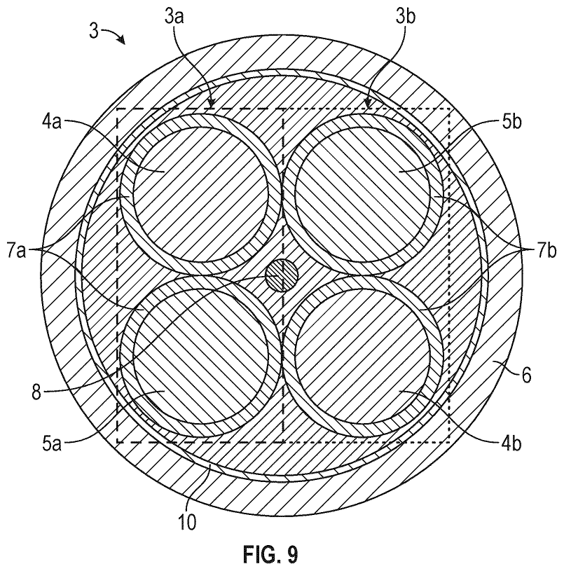

FIG. 9 shows a schematic cross-section (end view) of another capacitive cable according to an embodiment of the first aspect of the invention, wherein the bundles are arranged into two capacitive sub-cables distributed laterally with respect to each other, and wherein the bundles of each sub-cable are arranged vertically with respect to each other;

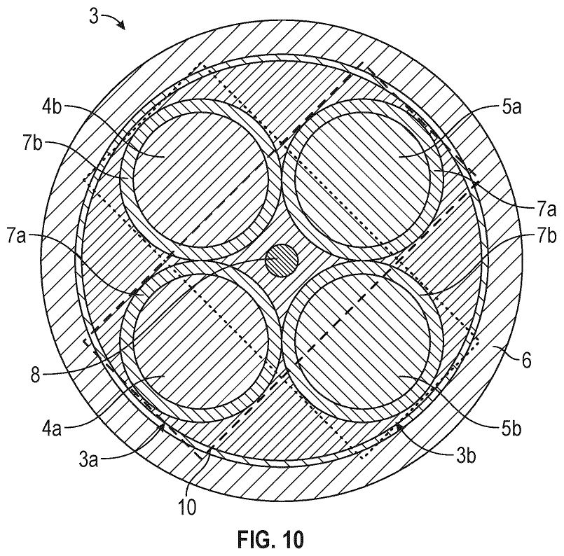

FIG. 10 shows a schematic cross-section (end view) of another capacitive cable according to an embodiment of the first aspect of the invention, wherein the bundles are arranged into two capacitive sub-cables distributed laterally with respect to each other, and wherein the bundles of each sub-cable are arranged diagonally with respect to each other;

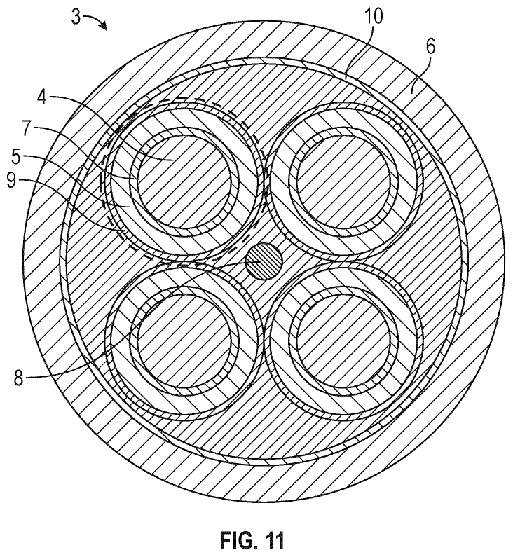

FIG. 11 shows a schematic cross-section (end view) of another capacitive cable according to an embodiment of the first aspect of the invention, wherein the bundles are arranged into four capacitive sub-cables distributed laterally with respect to each other;

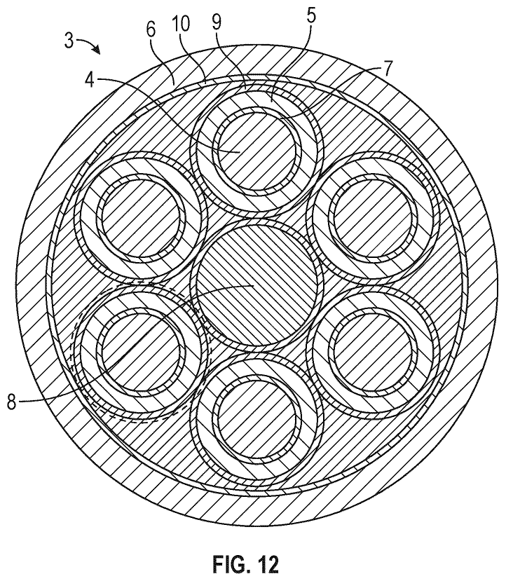

FIG. 12 shows a schematic cross-section (end view) of another capacitive cable according to an embodiment of the first aspect of the invention, wherein the bundles are arranged into six capacitive sub-cables distributed laterally with respect to each other;

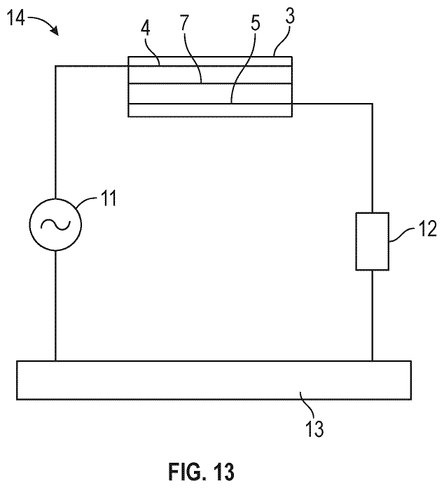

FIG. 13 shows a circuit diagram of a capacitive cable according to the first aspect of the invention in use according to an embodiment of the second aspect of the invention;

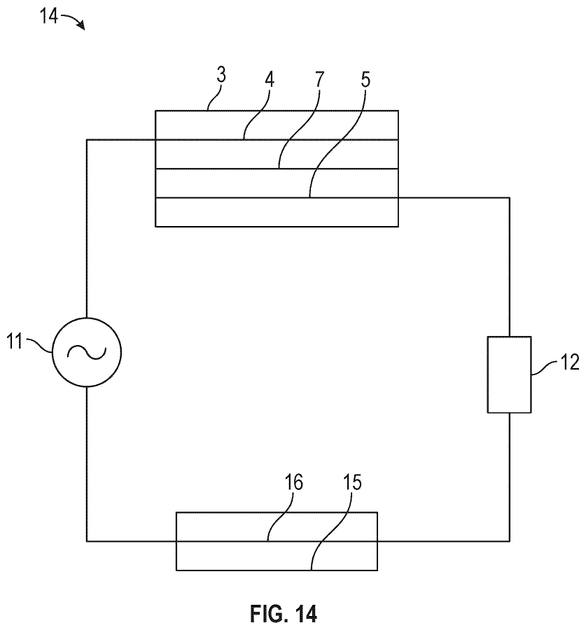

FIG. 14 shows a circuit diagram of a capacitive cable according to the first aspect of the invention in use according to another embodiment of the second aspect of the invention;

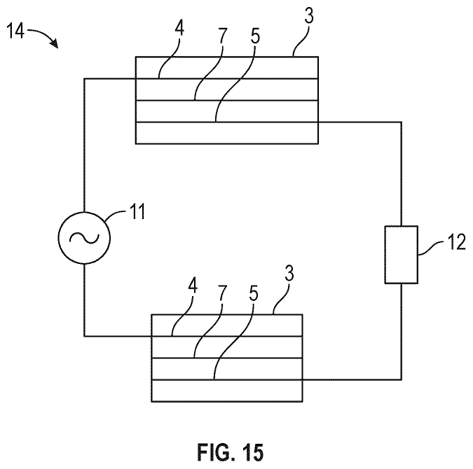

FIG. 15 shows a circuit diagram of two capacitive cables according to the first aspect of the invention in use according to the third aspect of the invention;

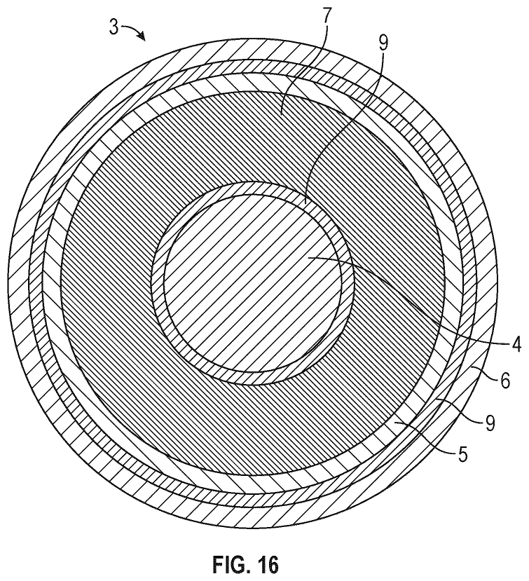

FIG. 16 shows a schematic cross-section (end view) of a capacitive cable according to an embodiment of the first aspect of the invention; and

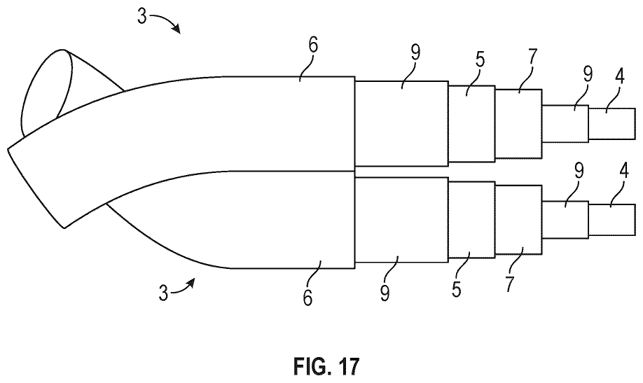

FIG. 17 shows a schematic extruded side view of two of the cables of FIG. 16 woven/wound around each other.

### EXAMPLE 1—BUNDLE

Referring to FIG. 1, a bundle 1 of the invention comprises a plurality of conductors 2 woven/wound around each other such that each individual conductor repeatedly transitions, along a length of the bundle, between an outside of the bundle and an inside of the bundle.

The proportion of the length of the bundle over which each conductor is at the outside of the bundle is similar between the conductors. Each conductor is individually insulated (insulation not shown in FIG. 1) from all of the other conductors in the bundle.

### EXAMPLE 2—LOW RESISTANCE CAPACITIVE CABLE COMPRISING ONE BUNDLE

Referring to FIGS. 2 and 3, a capacitive cable 3 comprises a first plurality of conductors 4 and a second plurality of conductors 5 woven/wound around each other into a single bundle 1. The single bundle is radially surrounded by an outer sheath 6, which protects the bundle from the surrounding environment.

Each conductor in the first and second pluralities of conductors is individually insulated using dielectric material (not shown in FIGS. 2 and 3) such that, when the capacitive cable is in use, a capacitive relationship arises between the first and second pluralities of conductors along the length of the capacitive cable.

### EXAMPLE 3—LOW RESISTANCE CAPACITIVE CABLE COMPRISING TWO BUNDLES DISTRIBUTED RADIALLY WITH RESPECT TO EACH OTHER

Referring to FIG. 4, a capacitive cable 3 comprises a first plurality of conductors 4 woven/wound into a first bundle and a second plurality of conductors 5 woven/wound into a second bundle.

The bundle formed of the first plurality of conductors is positioned in the centre of the cable (when viewed in cross-section from one end of the cable) and is surrounded radially by a layer of dielectric material 7. Radially outwards from the dielectric material, the bundle formed of the second plurality of conductors is wrapped around the layer of dielectric material, and an outer sheath 6 is then wrapped around the other components of the cable to protect the internal components of the cable from the surrounding environment.

Both the first plurality of conductors and the second plurality of conductors are woven/wound in such a way that the bundles they respectively form are in the form of Litz wire.

Each conductor is individually insulated from every other conductor (insulation not shown in FIG. 4). The arrangement is such that a capacitive relationship arises between the first and second bundles when the first plurality of conductors is connected to a power source but not to a load and the second plurality of conductors is connected to the load but not to the power source, i.e. when the capacitive cable is in use, transmitting power from the source to the load.

The two bundles are arranged such that the second plurality of conductors is radially outwards of the first plurality of conductors, when the cable is viewed in cross-section from one end thereof.

### EXAMPLE 4—LOW RESISTANCE CAPACITIVE CABLE COMPRISING TWO BUNDLES DISTRIBUTED LATERALLY WITH RESPECT TO EACH OTHER

Referring to FIG. 5, a capacitive cable 3 comprises a first plurality of conductors 4 woven/wound into a first bundle and a second plurality of conductors 5 woven/wound into a second bundle. Each bundle is surrounded radially by a layer of dielectric material 7. An outer sheath 6 is wrapped around these components of the cable to protect the internal components of the cable from the surrounding environment.

Each conductor is individually insulated from every other conductor (insulation not shown in FIG. 5). The arrangement is such that a capacitive relationship arises between the first and second bundles when the first plurality of conductors is connected to a power source but not to a load and the second plurality of conductors is connected to the load but not to the power source, i.e. when the capacitive cable is in use, transmitting power from the source to the load.

The two bundles are arranged such that the second plurality of conductors is laterally adjacent to the first plurality of conductors, when the cable is viewed in cross-section from one end thereof.

### EXAMPLE 5—LOW RESISTANCE CAPACITIVE CABLE COMPRISING TWO PLURALITIES OF BUNDLES DISTRIBUTED LATERALLY WITH RESPECT TO EACH OTHER

Referring to FIG. 6, a capacitive cable 3 comprises a first plurality of conductors 4 woven/wound into a first plurality of bundles, as well as a second plurality of conductors 5 woven/wound into a second plurality of bundles. Each conductor is individually insulated from every other conductor (insulation not shown in FIG. 6). Furthermore, each bundle is radially surrounded by a layer of dielectric material 7.

The first and second pluralities of bundles are arranged in a concentric ring around a former 8, such that the former is positioned in the centre of the cable (when viewed in cross-section from one end of the cable). An outer sheath 6 is positioned around the outside of the other components of the cable to protect these other components from the surrounding environment and to hold the other components of the cable in position.

It will be appreciated that this capacitive cable is particularly suitable for transmitting power in a three-phase manner when used in a power transmission system. This is because the capacitive cable comprises six bundles of conductors (three formed by/of the first plurality of conductors and three formed by/of the second plurality of conductors). These six bundles of conductors can be connected as three pairs of bundles (one bundle of the first plurality of conductors and one bundle of the second plurality of conductors in each pair), with each pair respectively being used to transmit one phase of the transmitted power. In this manner, each pair of bundles can be thought of as a capacitive sub-cable, since a capacitive relationship will arise between the two bundles in each pair when the capacitive cable is in use, transmitting power.

### EXAMPLE 6—LOW RESISTANCE CAPACITIVE CABLE COMPRISING A CONDUCTIVE SCREEN

Referring to FIG. 7, a capacitive cable 3 comprises a first plurality of conductors 4 and a second plurality of conductors 5 woven/wound into a single bundle. Each conductor is individually insulated from the other conductors in the bundle using dielectric material (not shown in FIG. 7). The bundle is radially surrounded by a layer of insulation 9, which is in turn radially surrounded by a conductive screen 10. Radially outwards of the conductive screen is a protective outer sheath 6.

In this capacitive cable, the conductive screen comprises a plurality of conductors (not shown in FIG. 7) woven/wound around each other such that the conductive screen is formed of Litz wire.

### EXAMPLE 7—LOW RESISTANCE CAPACITIVE CABLE COMPRISING BUNDLES ARRANGED INTO TWO CAPACITIVE SUB-CABLES DISTRIBUTED RADIALLY WITH RESPECT TO EACH OTHER

Referring to FIG. 8, a capacitive cable 3 comprises a first plurality of conductors woven/wound into a first bundle 4a and a second bundle 4b, as well as a second plurality of conductors woven/wound into a third bundle 5a and a fourth bundle 5b. The individual conductors are not shown in FIG. 8.

The first bundle 4a is positioned in the centre of the cable (when viewed in cross-section from one end of the cable) and is surrounded radially by a layer of dielectric material 7a. Radially outwards from the dielectric material, the third bundle 5a is wrapped around the layer of dielectric material. The first and third bundles with the dielectric material positioned between them collectively form a first capacitive sub-cable 3a.

A layer of insulation 9 is wrapped around the first sub-cable 3a, separating the first sub-cable 3a from a second sub-cable 3b.

The second bundle 4b is wrapped around the layer of insulation and is itself surrounded by a layer of dielectric material 7b. Radially outwards of the layer of dielectric material 7b is the fourth bundle 5b. The second and fourth bundles with the dielectric material positioned between them collectively form the second capacitive sub-cable 3b.

An outer sheath 6 is wrapped around all of the other components of the cable to protect the internal components of the cable from the surrounding environment.

Both the first plurality of conductors and the second plurality of conductors are woven/wound in such a way that the four bundles formed thereby are in the form of Litz wire.

Each conductor is individually insulated from every other conductor (insulation not shown in FIG. 8). The arrangement is such that a capacitive relationship arises between the first and third bundles, as well as between the second and fourth bundles, when the first plurality of conductors is connected to a power source but not to a load and the second plurality of conductors is connected to the load but not to the power source, i.e. when the capacitive cable is in use, transmitting power.

By including two sub-cables 3a, 3b within the capacitive cable 3, one of the sub-cables may be used as a transmission line, whilst the other sub-cable may be used as a return line, when the capacitive cable 3 is used in a power transmission system. Thus, in this manner, the transmission and return lines of the power transmission system are integrated into the same capacitive cable 3.

The two sub-cables are arranged such that the second sub-cable 3b is radially outwards of the first sub-cable 3a, when the cable is viewed in cross-section from one end thereof.

### EXAMPLE 8—LOW RESISTANCE CAPACITIVE CABLE COMPRISING BUNDLES ARRANGED INTO TWO CAPACITIVE SUB-CABLES DISTRIBUTED LATERALLY WITH RESPECT TO EACH OTHER WHEREIN THE BUNDLES OF EACH SUB-CABLE ARE ARRANGED VERTICALLY WITH RESPECT TO EACH OTHER

Referring to FIG. 9, a capacitive cable 3 comprises a first plurality of conductors woven/wound into a first bundle 4a and a second bundle 4b, as well as a second plurality of conductors woven/wound into a third bundle 5a and a fourth bundle 5b. The individual conductors are not shown in FIG. 9.

The four bundles are arranged around a former 8.

The first bundle 4a and the third bundle 5a are each radially surrounded by a layer of dielectric material 7a. The first and third bundles 4a, 5a and their respective dielectric layers 7a are arranged laterally with respect to each other to form a first capacitive sub-cable 3a (indicated by the dashed lines in FIG. 9).

The second bundle 4b and the fourth bundle 5b are each radially surrounded by a layer of dielectric material 7b. The first and third bundles 4b, 5b and their respective dielectric layers 7b are arranged laterally with respect to each other to form a second capacitive sub-cable 3b (indicated by the dotted lines in FIG. 9).

The first and second sub-cables 3a, 3b are arranged vertically with respect to each other in the capacitive cable 3.

A layer of insulation (not shown in FIG. 9) is wrapped around the first and second sub-cables 3a, 3b, separating the two sub-cables from a conductive screen 10 that radially surrounds the sub-cables 3a, 3b.

An outer sheath 6 is wrapped around all of the other components of the cable to protect the internal components of the cable from the surrounding environment.

Each conductor is individually insulated from every other conductor (insulation not shown in FIG. 9). The arrangement is such that a capacitive relationship arises between the first and third bundles, as well as between the second and fourth bundles, when the first plurality of conductors is connected to a power source but not to a load and the second plurality of conductors is connected to the load but not to the power source, i.e. when the capacitive cable is in use, transmitting power.

By including two sub-cables 3a, 3b within the capacitive cable 3, one of the sub-cables may be used as a transmission line, whilst the other sub-cable may be used as a return line, when the capacitive cable 3 is used in a power transmission system. Thus, in this manner, the transmission and return lines of the power transmission system are integrated into the same capacitive cable 3. It will be appreciated that the conductive screen may alternatively be used as the return line.

### EXAMPLE 9—LOW RESISTANCE CAPACITIVE CABLE COMPRISING BUNDLES ARRANGED INTO TWO CAPACITIVE SUB-CABLES DISTRIBUTED LATERALLY WITH RESPECT TO EACH OTHER, WHEREIN THE BUNDLES OF EACH SUB-CABLE ARE ARRANGED DIAGONALLY WITH RESPECT TO EACH OTHER

Referring to FIG. 10, a capacitive cable 3 comprises a first plurality of conductors woven/wound into a first bundle 4a and a second bundle 4b, as well as a second plurality of conductors woven/wound into a third bundle 5a and a fourth bundle 5b. The individual conductors are not shown in FIG. 10.

The four bundles are arranged around a former 8.

The first bundle 4a and the third bundle 5a are each radially surrounded by a layer of dielectric material 7a. The first and third bundles 4a, 5a and their respective dielectric layers 7a are arranged laterally with respect to each other to form a first capacitive sub-cable 3a (indicated by the dashed lines in FIG. 10).

The second bundle 4b and the fourth bundle 5b are each radially surrounded by a layer of dielectric material 7b. The first and third bundles 4b, 5b and their respective dielectric layers 7b are arranged laterally with respect to each other to form a second capacitive sub-cable 3b (indicated by the dotted lines in FIG. 10).

The first and second sub-cables 3a, 3b are arranged diagonally with respect to each other in the capacitive cable 3.

A layer of insulation (not shown in FIG. 10) is wrapped around the first and second sub-cables 3a, 3b, separating the two sub-cables from a conductive screen 10 that radially surrounds the sub-cables 3a, 3b.

An outer sheath 6 is wrapped around all of the other components of the cable to protect the internal components of the cable from the surrounding environment.

Each conductor is individually insulated from every other conductor (insulation not shown in FIG. 10). The arrangement is such that a capacitive relationship arises between the first and third bundles, as well as between the second and fourth bundles, when the first plurality of conductors is connected to a power source but not to a load and the second plurality of conductors is connected to the load but not to the power source, i.e. when the capacitive cable is in use, transmitting power.

By including two sub-cables 3a, 3b within the capacitive cable 3, one of the sub-cables may be used as a transmission line, whilst the other sub-cable may be used as a return line, when the capacitive cable 3 is used in a power transmission system. Thus, in this manner, the transmission and return lines of the power transmission system are integrated into the same capacitive cable 3. It will be appreciated that the conductive screen may alternatively be used as the return line.

### EXAMPLE 10—TRANSMISSION AND RETURN LINES INTEGRATED INTO THE SAME CAPACITIVE CABLE AND DISTRIBUTED LATERALLY WITH RESPECT TO EACH OTHER

Referring to FIG. 11, a capacitive cable 3 comprises a first plurality of conductors 4 woven/wound into four bundles, as well as a second plurality of conductors 5 woven/wound into four bundles. The individual conductors are not shown in FIG. 11.

The eight bundles of conductors are arranged into four sub-cables distributed/separated from each other laterally within the capacitive cable 3 (one such sub-cable being indicated by the dashed lines in FIG. 11). Each sub-cable comprises one of the four bundles formed by the first plurality of conductors, positioned at the centre of the sub-cable (when viewed in cross-section from one end thereof). That bundle is radially surrounded by a layer of dielectric material 7, which is itself radially surrounded by one of the four bundles formed by the second plurality of conductors. As its radially outermost layer, each sub-cable then comprises a layer of insulation 9 to electrically isolate the sub-cable from the other three sub-cables.

The four sub-cables are arranged in a ring around a former 8 and are collectively radially surrounded by a conductive screen 10. These components of the capacitive cable are all collectively encased in an outer sheath 6, which protects the internal components of the cable from the surrounding environment.

Each conductor is individually insulated from every other conductor (insulation not shown in FIG. 11). The arrangement is such that a capacitive relationship arises between the two bundles of conductors within each sub-cable when the first plurality of conductors is connected to a power source but not to a load and the second plurality of conductors is connected to the load but not to the power source, i.e. when the capacitive cable is in use, transmitting power.

By including four sub-cables within the capacitive cable 3, one or more of the sub-cables may be used as a transmission line, whilst one or more of the other sub-cables may be used as a return line, when the capacitive cable 3 is used in a power transmission system. Thus, in this manner, the transmission and return lines of the power transmission system are integrated into the same capacitive cable 3. It will be appreciated that the conductive screen may alternatively be used as the return line.

### EXAMPLE 11—TRANSMISSION AND RETURN LINES INTEGRATED INTO THE SAME CAPACITIVE CABLE AND DISTRIBUTED LATERALLY WITH RESPECT TO EACH OTHER

Referring to FIG. 12, a capacitive cable 3 comprises a first plurality of conductors 4 woven/wound into six bundles, as well as a second plurality of conductors 5 woven/wound into six bundles. The individual conductors are not shown in FIG. 12.

The twelve bundles of conductors are arranged into six sub-cables distributed/separated from each other laterally within the capacitive cable 3 (one such sub-cable being indicated by the dashed lines in FIG. 12). Each sub-cable comprises one of the six bundles formed by the first plurality of conductors, positioned at the centre of the sub-cable (when viewed in cross-section from one end thereof). That bundle is radially surrounded by a layer of dielectric material 7, which is itself radially surrounded by one of the six bundles formed by the second plurality of conductors. As its radially outermost layer, each sub-cable then comprises a layer of insulation 9 to electrically isolate the sub-cable from the other five sub-cables.

The six sub-cables are arranged in a ring around a former 8 and are collectively radially surrounded by a conductive screen 10. These components of the capacitive cable are all collectively encased in an outer sheath 6, which protects the internal components of the cable from the surrounding environment.

Each conductor is individually insulated from every other conductor (insulation not shown in FIG. 12). The arrangement is such that a capacitive relationship arises between the two bundles of conductors within each sub-cable when the first plurality of conductors is connected to a power source but not to a load and the second plurality of conductors is connected to the load but not to the power source, i.e. when the capacitive cable is in use, transmitting power.

By including six sub-cables within the capacitive cable 3, one or more of the sub-cables may be used as a transmission line, whilst one or more of the other sub-cables may be used as a return line, when the capacitive cable 3 is used in a power transmission system. Thus, in this manner, the transmission and return lines of the power transmission system are integrated into the same capacitive cable 3. It will be appreciated that the conductive screen may alternatively be used as the return line.

Since the capacitive cable 3 has six sub-cables, this cable is particularly suitable for transmitting power in a three-phase manner, i.e. by connecting the six sub-cables as three pairs of sub-cables, with each pair being used to transmit one of the three phases. To maximise balance between the different pairs of sub-cables, the sub-cables may be connected in pairs to respective phases of a three-phase power supply (two sub-cables to each phase) such that the distance between the centres of the two sub-cables (when viewed in cross-section from one end thereof) in each pair is the same.

EXAMPLE 12—USE OF ONE CAPACITIVE CABLE IN A POWER TRANSMISSION SYSTEM Referring to FIG. 13, a capacitive cable 3 is used for transmitting power from a source 11 to a load 12. The capacitive cable is used as a transmission line by connecting a first plurality of conductors 4 of the capacitive cable to the source and connecting a second plurality of conductors 5 of the capacitive cable to the load. A layer of dielectric material 7 is positioned between the first and second pluralities of conductors, and ensures a capacitive relationship arises between these pluralities of conductors once the power source is activated.

To ensure the circuit formed is a complete circuit, both the source and the load are connected to the ground 13, which acts as a return line for this circuit, before the power source is activated.

In this manner, power is efficiently transmitted from the source to the load via a power transmission system 14.

### EXAMPLE 13—USE OF ONE CAPACITIVE CABLE IN A POWER TRANSMISSION SYSTEM

Referring to FIG. 14, a capacitive cable 3 is used for transmitting power from a source 11 to a load 12. The capacitive cable is used as a transmission line by connecting a first plurality of conductors 4 of the capacitive cable to the source and connecting a second plurality of conductors 5 of the capacitive cable to the load. A layer of dielectric material 7 is positioned between the first and second pluralities of conductors, and ensures a capacitive relationship arises between these pluralities of conductors once the power source is activated.

To ensure the circuit formed is a complete circuit, both the source and the load are connected to a conventional cable 15, which acts as a return line for this circuit, before the power source is activated. The conventional cable comprises a plurality of conductors 16 connected to both the source and the load.

In this manner, power is efficiently transmitted from the source to the load via a power transmission system 14.

### EXAMPLE 14—USE OF TWO CAPACITIVE CABLES IN A POWER TRANSMISSION SYSTEM

Referring to FIG. 15, two capacitive cables 3 are used in a power transmission system 14. A first plurality of conductors 4 of each cable is connected to a power source 11, and a second plurality of conductors 5 of each cable is connected to a load 12.

Dielectric material 7 between the first and second pluralities of conductors ensures a capacitive relationship is established between these pluralities of conductors when the power transmission system is active, transmitting power from the source to the load.

Upon activation of the power source, power is transmitted via the first capacitive cable, which acts as a transmission line, to the load. The load uses an amount of the power supplied to it, and the remaining power is returned to the source via the second capacitive cable, which acts as a return line.

### EXAMPLE 15—CONSTRUCTION OF A LOW RESISTANCE CAPACITIVE CABLE

Referring to FIG. 16, a capacitive cable 3 was manufactured having the following structure radially outwards, from the centre to the circumference (when viewed in cross-section from one end of the cable):
a first plurality of conductors 4 (individual conductors not shown in FIG. 16),
a layer of insulation 9,
a layer of dielectric material 7,
a second plurality of conductors 5 (individual conductors not shown in FIG. 16),
a further layer of insulation 9, and
an outer sheath 6.

The first plurality of conductors, woven/wound into a bundle at the centre of the cable (when viewed in cross-section from one end of the cable, as in FIG. 16), comprised 1600 individual copper conductors, each individually insulated using solderable enamel (insulation not shown in FIG. 16). Each insulated conductor had a diameter of 0.1 mm (0.108 mm to 0.117 mm including the insulation), yielding a total cross-sectional area of the first plurality of conductors of 12.57 mm².

Radially surrounding the first plurality of conductors was a layer of helical polyethylene terephthalate (“PET”) separation tape insulation. The insulation was 23 μm thick and had a groove (not shown in FIG. 16) arranged along its inner (radially inwards) surface corresponding to the arrangement of conductors in the first plurality of conductors. This groove ensured the insulation had a snug fit against the first plurality of conductors and held those conductors in their correct positions in the bundle.

The next layer radially outwards from the insulation was a layer of PA12 L25 W20Y (Grade 12 Nylon) as dielectric material. This layer of Nylon was 0.3 mm thick.

Arranged around the layer of dielectric material was a second plurality of copper conductors, comprising 1620 individual copper conductors each individually insulated using solderable enamel (insulation not shown in FIG. 16), woven/wound into a bundle. Each insulated conductor had a diameter of 0.1 mm (0.108 mm to 0.117 mm including the insulation) and thus, similarly to the first plurality of conductors, the total cross-sectional area of the second plurality of conductors was 12.72 mm².

In both the first and second pluralities of conductors, the conductors were woven/wound such that they each formed Litz wire.

Radially outwards from the second plurality of conductors, a further layer of helical polyethylene terephthalate (“PET”) separation tape insulation was arranged around the second plurality of conductors. This layer of insulation was 23 μm thick and, like the layer of insulation radially adjacent to the first plurality of conductors, had a holding groove (not shown in FIG. 16) along its inner surface to hold the second plurality of conductors in their correct positions in the bundle.

The above cable components were then radially surrounded with an outer sheath made of low density polyethylene. The outer sheath was 1.25 mm thick.

The complete, resulting cable had a diameter of between 10 mm and 11 mm.

### EXAMPLE 16—USE OF TWO CAPACITIVE CABLES OF EXAMPLE 15

Referring to FIG. 16, two capacitive cables 3 were constructed in accordance with the capacitive cable of Example 15.

These capacitive cables were used in a power transmission system wherein the first plurality of conductors of each cable was connected to a power source but not to a load and the second plurality of conductors of each cable was connected to the load but not to the power source. Thus, one of the cables was used as a transmission line, and the other cable was used as a return line, in this power transmission system (in a similar manner to that shown in FIG. 15).

In this system, the power source supplied power at a voltage of 900 V to 1 kV, a current of 17-19 A, and a frequency of 85.22 kHz. The capacitive cables were each 107 m in length.

The inherent electrical properties of the capacitive cables were measured at 85 kHz to 85.5 kHz (the resonant frequency of the two capacitive cables connected in series) and these cables were each found to have an inductance of 0.23458 mH/km, a capacitance of 326.17 nF/km (the active capacitance value at 85 kHz to 85.5 kHz when the two cables were connected capacitively in series), and a resistance of 740.6 mΩ/km (captured/measured during a factory acceptance test). The Grade 12 Nylon used as the dielectric layers of each cable had a dielectric constant of 8.8 (according to its datasheet).

It was found that, when this power transmission system was activated, the voltage lost along the length of the cable was 63.32 V. Thus, power was efficiently transmitted via this power transmission system at high frequency.

### EXAMPLE 17—USE OF TWO CAPACITIVE CABLES OF EXAMPLE 15 WOVEN/WOUND AROUND EACH OTHER

Referring to FIG. 17, two capacitive cables 3 are constructed in accordance with the capacitive cable of Example 15 and used in a power transmission system.

The two capacitive cables are woven/wound each other, thereby reducing electric and magnetic fields generated by the cables compared to a power transmission system wherein the capacitive cables are not woven/wound around each other.

### EXAMPLE 18—COMPARISON OF A LOW RESISTANCE CAPACITIVE CABLE AND A LOW RESISTANCE CONVENTIONAL CABLE HAVING SIMILAR STRUCTURES TO EACH OTHER

Referring to FIG. 16, two capacitive cables 3 were constructed in accordance with the capacitive cable of Example 15.

These capacitive cables were used in a power transmission system wherein the first plurality of conductors of each cable was connected to a power source but not to a load and the second plurality of conductors of each cable was connected to the load but not to the power source. Thus, one of the cables was used as a transmission line, and the other cable was used as a return line, in this power transmission system (in a similar manner to that shown in FIG. 15). It will be appreciated that the two capacitive cables may accurately be described as having been connected in series with each other in this power transmission system. The cables were positioned next to each other such that their outer sheaths were in contact with each other along their lengths.

The capacitive cables were each initially manufactured to be 130 m in length. The lengths of each of the two cables were then gradually decreased and the resonant frequency of the two cables connected in series with each other in use measured at different cable lengths. No other electrical parameters were changed. Relevant data obtained are shown in Table 1.

TABLE 1
Resonant Frequency of Two Capacitive Cables Connected
in Series with Each Other at Different Lengths

| Length | Total Length | Induc- | Capaci- | Resonant |
|---|---|---|---|---|
| of Each | of Both | tance / | tance / | Frequency / |
| Cable / m | Cables / m | μH | nF | kHz |
| 130 | 260 | 59.90 | 86.18 | 70.5 to 71.0 |
| 128 | 256 | 58.97 | 85.20 | 71.0 to 72.0 |
| 126 | 252 | 58.05 | 83.80 | 72.0 to 73.0 |
| 124 | 248 | 57.14 | 82.40 | 73.0 to 74.0 |
| 119 | 238 | 54.83 | 79.10 | 76.0 to 77.0 |
| 114 | 228 | 52.53 | 75.70 | 79.5 to 81.0 |
| 110 | 220 | 50.68 | 72.00 | 83.0 to 84.0 |
| 109 | 218 | 50.22 | 71.30 | 83.0 to 84.0 |
| 107 | 214 | 50.20 | 69.67 | 85.0 to 85.5 |

From Table 1, it can be seen that a resonant frequency of about 85 kHz was achieved when each cable had a length of 107 m. It will be appreciated that cables capable of operating at a resonant frequency of 85 kHz are advantageous because this is a resonant frequency approved by industry standards associated with many high frequency applications, such as wireless electric vehicle charging systems. It will also be appreciated that a resonant frequency of 85 kHz could be achieved using cables having lengths other than 107 m by changing, for example, the dimensions/structure of the capacitive cable, e.g. the type and/or thickness of dielectric material used, the topology and/or shape of the conductors, and/or by connecting one or more additional electrical components, such as capacitors and/or inductors, into the circuit.

The 107 m-long cables were then tested to compare whether these were more efficient when used to transmit power at a resonant frequency of about 85 kHz when used as capacitive cables or when used as conventional cables of similar structure. To do this, the cables were first connected as capacitive cables, i.e. with the first plurality of conductors of each cable connected to the power source but not to the load and with the second plurality of conductors of each cable connected to the load but not to the power source. The first and second pluralities of conductors were then directly electrically connected to each other at each end of the cables, causing each cable to transmit power as a conventional cable rather than a capacitive cable. Various electrical parameters and features of the cables were measured while the cables were used as capacitive cables and the same electrical parameters were then measured again while the cables were used as conventional cables. In this manner, a direct comparison between two capacitive cables of the invention and two conventional cables of similar structures to the capacitive cables was performed.

The first electrical parameter compared between the capacitive and conventional versions of the cables was the harmonic content at the input terminal of the cables while in operation. Relevant data obtained are shown in Tables 2 and 3. Table 2 shows data relating to the total harmonic distortion due to voltage, whilst Table 3 shows data relating to total harmonic distortion due to current.

TABLE 2
Total Harmonic Distortion of Capacitive and Conventional
Cables of Similar Structures Due to Voltage

| Mode of Cable | Input Voltage | Input Voltage | Total Harmonic |
|---|---|---|---|
| Operation | (Vᵣₘₛ) / V | (V_{Fund}) / V | Distortion / % |
| Conventional | 995.04 | 985.48 | 13.790 |
| Capacitive | 964.89 | 960.59 | 9.468 |

TABLE 3
Total Harmonic Distortion of Capacitive and Conventional
Cables of Similar Structures Due to Current

| Mode of Cable | Input Current | Input Current | Total Harmonic |
|---|---|---|---|
| Operation | (Iᵣₘₛ) / A | (I_{Fund}) / A | Distortion / % |
| Conventional | 18.864 | 18.829 | 6.039 |
| Capacitive | 20.586 | 20.571 | 3.483 |

From Tables 2 and 3, it can be seen that the cables exhibited lower total harmonic distortion due to voltage and lower total harmonic distortion due to current when functioning as capacitive cables compared to when functioning as conventional cables. Thus, it can be seen from these data that the capacitive cables of the invention exhibited improved harmonic filtration compared to conventional cables having similar structures thereto.

The second electrical parameter compared between the capacitive and conventional versions of the cables was voltage drop/loss along the length of the cables. Measurements were made after 3 minutes and 50 seconds (230 seconds) of operation, and then again at 22 minutes and 27 seconds (1347 seconds) of operation. Relevant data obtained are shown in Table 4.

TABLE 4
Voltage Losses Along Capacitive and Conventional
Cables of Similar Structures

| | | Input | Output | Voltage Lost |
|---|---|---|---|---|
| Mode of Cable | | Voltage | Voltage | Between |
| Operation | Time / s | (Vᵣₘₛ) / V | (Vᵣₘₛ) / V | Input and Output / % |
| Conventional | 230 | 970.47 | 831.59 | 14.3 |
| Capacitive | 230 | 951.28 | 887.96 | 6.7 |
| Conventional | 1347 | 970.28 | 833.18 | 14.1 |
| Capacitive | 1347 | 953.50 | 862.74 | 9.5 |

This experiment was repeated using a different input voltage and by making measurements at different timepoints. Specifically, the input voltage was controlled such that it was approximately the same for both the capacitive and conventional versions of the cables at corresponding timepoints. Relevant data obtained are shown in Table 5.

TABLE 5
Voltage Losses Along Capacitive and Conventional
Cables of Similar Structures

| | | Input | Output | Voltage Lost |
|---|---|---|---|---|
| Mode of Cable | | Voltage | Voltage | Between |
| Operation | Time / s | (Vᵣₘₛ) / V | (Vᵣₘₛ) / V | Input and Output / % |
| Conventional | 5 | 998.70 | 794.90 | 20.4 |
| Capacitive | 35 | 998.73 | 916.79 | 8.2 |
| Conventional | 263 | 999.87 | 797.65 | 20.2 |
| Capacitive | 214 | 999.93 | 911.59 | 8.8 |

From Tables 4 and 5, it can be seen that the capacitive cables exhibited lower voltage losses along their lengths than the conventional cables.

This experiment was again repeated using a different input voltage and by making measurements at different timepoints. In this repeat, the input voltage was controlled in order to achieve the same output voltage for the capacitive and conventional versions of the cables at corresponding timepoints. Relevant data obtained are shown in Table 6.

TABLE 6
Voltage Losses Along Capacitive and Conventional
Cables of Similar Structures

| | | Input | Output | Voltage Lost |
|---|---|---|---|---|
| Mode of Cable | | Voltage | Voltage | Between |
| Operation | Time / s | (Vᵣₘₛ) / V | (Vᵣₘₛ) / V | Input and Output / % |
| Conventional | 5 | 998.70 | 794.90 | 20.4 |
| Capacitive | 115 | 858.70 | 794.52 | 7.47 |
| Conventional | 263 | 999.87 | 797.65 | 20.2 |
| Capacitive | 350 | 865.58 | 795.94 | 8.05 |

From Table 6, it can be seen that the capacitive cables exhibited lower voltage losses along their lengths than the conventional cables. This allowed the same output voltage to be achieved using a lower input voltage (for the capacitive cables compared to the conventional cables), which meant the capacitive cables were more efficient than the conventional cables.

All experiments were performed using a single-phase power supply, and thus using the cables as single-phase cables.

### PARTS LIST

1 bundle
2 conductors
3 capacitive cable
4 first plurality of conductors
5 second plurality of conductors
6 outer sheath
7 dielectric material
8 former
9 insulation
10 conductive screen
11 power source
12 load
13 ground
14 power transmission system
15 conventional cable
16 conductors of a conventional cable

1. A power transmission system, comprising:
(a) a power source,
(b) a load, and
(c) a capacitive cable,
wherein the capacitive cable comprises:
(i) a first plurality of conductors,
(ii) a second plurality of conductors, and
(iii) a dielectric material between the first plurality of conductors and the second plurality of conductors,
wherein each conductor is individually insulated, and
wherein at least one of the conductors of the first plurality of conductors and at least one of the conductors of the second plurality of conductors are woven or wound into one or more bundles such that each individual conductor repeatedly transitions, along a length of the one or more bundles, between an outside of the one or more bundles and an inside of the one or more bundles, and
wherein:
(i) the first plurality of conductors of the capacitive cable is connected to the power source but not to the load, and
(ii) the second plurality of conductors of the capacitive cable is connected to the load but not to the power source.

2. A power transmission system as claimed in claim 1, wherein all of the conductors of the capacitive cable are woven or wound into the one or more bundles.

3. A power transmission system as claimed in claim 1, wherein the proportion of the length of the one or more bundles over which each conductor of the capacitive cable is at the outside of the bundle is similar or the same between the conductors.

4. A power transmission system as claimed in claim 1, wherein the conductors of the capacitive cable are woven or wound into one bundle and each conductor is individually insulated using a dielectric material.

5. A power transmission system as claimed in claim 1, wherein the conductors of the capacitive cable are woven or wound into a plurality of bundles.

6. A power transmission system as claimed in claim 5, wherein the first plurality of conductors of the capacitive cable is woven or wound into a first bundle and the second plurality of conductors of the capacitive cable is woven or wound into a second bundle.

7. A power transmission system as claimed in claim 5, wherein the first plurality of conductors of the capacitive cable is woven or wound into a first plurality of bundles and the second plurality of conductors of the capacitive cable is woven or wound into a second plurality of bundles.

8. A power transmission system as claimed in claim 7, wherein the first plurality of bundles and the second plurality of bundles are arranged into one or more concentric rings of bundles.

9. A power transmission system as claimed in claim 1, wherein each bundle is Litz wire.

10. (canceled)

11. (canceled)

12. (canceled)

13. (canceled)

14. A power transmission system as claimed in claim 1, wherein the insulation of the first plurality of conductors of the capacitive cable is of a different colour to the insulation of the second plurality of conductors of the capacitive cable.

15. A power transmission system as claimed in claim 1, wherein the bundles are arranged into two or more capacitive sub-cables within the capacitive cable.

16. A power transmission system as claimed in claim 1, wherein the first plurality of conductors of the capacitive cable are connected to each other at a first end of the capacitive cable and the second plurality of conductors of the capacitive cable are connected to each other at a second end of the capacitive cable.

17. (canceled)

18. Use of a capacitive cable in a power transmission system, wherein the capacitive cable comprises:
(a) a first plurality of conductors,
(b) a second plurality of conductors, and
(c) a dielectric material between the first plurality of conductors and the second plurality of conductors,
wherein each conductor is individually insulated, and
wherein at least one of the conductors of the first plurality of conductors and at least one of the conductors of the second plurality of conductors are woven or wound into one or more bundles such that each individual conductor repeatedly transitions, along a length of the one or more bundles, between an outside of the one or more bundles and an inside of the one or more bundles,
wherein:
(i) the first plurality of conductors is connected to a power source but not to a load, and
(ii) the second plurality of conductors is connected to the load but not to the power source.

19. (canceled)

20. Use of a first capacitive cable and a second capacitive cable in a power transmission system, wherein use of the first capacitive cable and use of the second capacitive cable are each use of a capacitive cable as claimed in claim 18.

21. (canceled)

22. Use of a first capacitive cable and a second capacitive cable as claimed in claim 20, wherein the first capacitive cable and the second capacitive cable are woven or wound around each other.

23. A method of transmitting power, the method comprising:
(a) connecting a first plurality of conductors of a capacitive cable to a power source but not to a load,
(b) connecting a second plurality of conductors of the capacitive cable to the load but not to the power source, and
(c) activating the power source,
wherein the capacitive cable comprises:
(i) the first plurality of conductors,
(ii) the second plurality of conductors, and
(iii) a dielectric material between the first plurality of conductors and the second plurality of conductors,
wherein each conductor is individually insulated, and
wherein at least one of the conductors of the first plurality of conductors and at least one of the conductors of the second plurality of conductors are woven or wound into one or more bundles such that each individual conductor repeatedly transitions, along a length of the one or more bundles, between an outside of the one or more bundles and an inside of the one or more bundles.

24. (canceled)

25. A power transmission system as claimed in claim 1, wherein the capacitive cable comprises:
(a) a third plurality of conductors,
(b) a fourth plurality of conductors, and
(c) a dielectric material between the third plurality of conductors and the fourth plurality of conductors,
wherein each conductor is individually insulated, and
wherein at least one of the conductors of the third plurality of conductors and at least one of the conductors of the fourth plurality of conductors are woven or wound into one or more bundles such that each individual conductor repeatedly transitions, along a length of the one or more bundles, between an outside of the one or more bundles and an inside of the one or more bundles,
wherein:
(i) the third plurality of conductors of the capacitive cable is connected to the power source but not to the load, and
(ii) the fourth plurality of conductors of the capacitive cable is connected to the load but not to the power source, and
wherein:
(i) the first plurality of conductors of the capacitive cable and the second plurality of conductors of the capacitive cable are collectively connected as a transmission line, and
(ii) the third plurality of conductors of the capacitive cable and the fourth plurality of conductors of the capacitive cable are collectively connected as a return line.

26. A capacitive cable, comprising:
(a) a first plurality of conductors for connection to a power source,
(b) a second plurality of conductors for connection to a load, and
(c) a dielectric material between the first plurality of conductors and the second plurality of conductors,
wherein each conductor is individually insulated,
wherein at least one of the conductors of the first plurality of conductors and at least one of the conductors of the second plurality of conductors are woven or wound into one or more bundles such that each individual conductor repeatedly transitions, along a length of the one or more bundles, between an outside of the one or more bundles and an inside of the one or more bundles,
wherein the first plurality of conductors is woven or wound into a first bundle and the second plurality of conductors is woven or wound into a second bundle, and
wherein the bundles are distributed radially with respect to each other.

27. A capacitive cable as claimed in claim 26, wherein each conductor is a tubular conductor.

28. A capacitive cable as claimed in claim 26, wherein each bundle is Litz wire.

29. A capacitive cable as claimed in claim 26, wherein the insulation of the first plurality of conductors is of a different colour to the insulation of the second plurality of conductors.

30. A capacitive cable as claimed in claim 26, wherein the first plurality of conductors is suitable to not be connected to the load, wherein the second plurality of conductors is suitable to not be connected to the power source, and wherein the capacitive cable comprises:
(a) a third plurality of conductors for connection to the power source but not to the load,
(b) a fourth plurality of conductors for connection to the load but not to the power source, and
(c) a dielectric material between the third plurality of conductors and the fourth plurality of conductors,
wherein the first plurality of conductors and the second plurality of conductors are collectively for connection as a transmission line,
wherein the third plurality of conductors and the fourth plurality of conductors are collectively for connection as a return line,
wherein each conductor is individually insulated, and
wherein at least one of the conductors of the third plurality of conductors and at least one of the conductors of the fourth plurality of conductors are woven or wound into one or more bundles such that each individual conductor repeatedly transitions, along a length of the one or more bundles, between an outside of the one or more bundles and an inside of the one or more bundles.

31. A capacitive cable as claimed in claim 26, wherein the first plurality of conductors are connected to each other at a first end of the capacitive cable and the second plurality of conductors are connected to each other at a second end of the capacitive cable.
